(19) United States
(12) Patent Application Publication
(10) Pub. No.: US 2024/0292974 A1
(43) Pub. Date: Sep. 5, 2024

(54) A COFFEE MACHINE

(71) Applicant: KARACA ZÜCCACIYE TICARET VE SANAYI ANONIM SIRKETI, Istanbul (TR)

(72) Inventor: Muzaffer KARACA, Istanbul (TR)

(21) Appl. No.: 18/573,561

(22) PCT Filed: Jun. 21, 2022
(86) PCT No.: PCT/TR2022/050626

§ 371 Date: Dec. 22, 2023

(30) Foreign Application Priority Data
Jun. 22, 2021 (TR) 2021/010134

(51) Int. Cl. A47J 31/52; A47J 31/00; A47J 31/44; G01F 23/292; G08B 21/18

(52) U.S. Cl. CPC A47J 31/525; A47J 31/007; A47J 31/4439; A47J 2203/00; G01F 23/292; G08B 21/182

(57) ABSTRACT

The present invention is related to a coffee machine comprising a first brewing chamber (9) and a second brewing chamber (10) located in a housing (8), a control panel (15) for selecting the brewing mode (16), one or more brewing buttons (26) (28) (30) (32) (34) located thereon, and a controller (18) having a processor (36), a memory module (40) and a speaker (42) associated with a signal transmission from the first brewing chamber (9) and the second brewing chamber (10); being the controller (18) configured to receive a notification signal by tripping the thermostat switch (24) set to transmit a signal from the first brewing chamber (9), and to wait for 5 minutes and then to play a brewing completed notification sound file (44) stored in a memory module (40) of the controller (18) through a speaker (42); and being the controller (18) also configured to play a brewing completed notification sound file (44) stored in the memory module (40) of the controller through the speaker (42) with a notification signal from the level sensor (20) set to transmit a signal from the second brewing chamber (10) to the controller (18).

### FIELD OF THE INVENTION

The invention is related to a coffee machine having an audible notification function and multiple brewing programs.

### STATE OF THE ART

Dating back to ancient times, coffee culture has become a part of daily life today at home, work, school, almost everywhere in life. Coffee, as a part of life, can now be prepared using the coffee machines manufactured with the developing technology. Today, the development of technology has resulted in the manufacturing of many types of coffee machines, such as office coffee machines, industrial coffee machines, home coffee machines and the like. With the widespread use of coffee machines, coffee machine technologies are being developed with many features and utilizing many branches of technology. Examples include coffee machines with multiple brewing programs or temperature sensitivity monitored by different types of sensors. Another example is the development of a coffee machine that, at the end of the coffee brewing process, provides an audible notification with a human voice to inform the user that the process is finished and the coffee is ready. With the development of such technologies, easy-to-prepare coffee products can be prepared conveniently and quickly.

Publication no. CN203059374 is related to the coffee machine with speech control function. The utility model describes a coffee machine with a speech control function. The coffee machine with speech control function consists of a machine body, a control circuit, a working panel, an audio input device and an audio output device. The control circuit is arranged inside the machine body. The operation panel is arranged on the machine body. The operation panel is electrically connected to the control circuit. The audio input device and audio output device are respectively arranged in the machine body. The audio input device and the audio output device are respectively and electrically connected to the control circuit. Furthermore, the coffee machine with speech control function has the advantages of achieving speech control, being convenient to operate, working fast, facilitating interaction with a user, and being fast in interacting with the user.

Another example of a Turkish coffee brewing process is disclosed in the invention that is described in the publication no. 2015/07207 entitled “Automatic frothy hot beverage or preferably Turkish coffee brewing machine”. In the publication, the Sensor-Lumina measurement technique based on visible light from an infrared LED or visible light emitting LED source (all colors of LEDs from blue to red or white LEDs can be used) is disclosed. Here, the pre-brewing and post-foaming levels of Turkish coffee in coffee pots are determined by photocells that function as LDR (Light Depended Resistor) for visible light. The photocells send signals to a microprocessor. With these signals, the microprocessor is enabled to stop a heater operating in the form of PWM (Pulse with Modulation). In this way, an automatic frothy hot beverage or Turkish coffee brewing machine has been created.

### SUMMARY OF THE INVENTION

The object of the invention is to develop a coffee machine with more than one brewing program that notifies the user of the end of the brewing process with an audible notification function.

In order to achieve the aforementioned objects, the invention provides a first brewing chamber and a second brewing chamber arranged in a housing; a first heater plate arranged at a bottom of the first brewing chamber; a first brewing compartment located in the first brewing chamber and aligned on the first heater plate; a second brewing compartment located in the second brewing chamber; a second heater plate located at a bottom of the second brewing compartment; a level sensor configured to detect a threshold of the liquid level in a brewing mode of the second brewing compartment; a thermostat switch configured to transmit mains power to the first heating plate when a brewing mode is on and to disconnect mains power from the first heating plate when the brewing mode is off; a control panel for providing a brewing mode option; and a coffee machine comprising one or more brewing buttons located thereon. In the invention, a controller comprising a processor, a memory module and a speaker associated with a signal transmission from the first brewing chamber and the second brewing chamber, wherein the controller is configured to receive a notification signal by tripping the thermostat switch set to transmit a signal from the first brewing chamber, and then to play a brewing completed notification sound file stored in the memory module of the controller through the speaker after 5 minutes; the controller is also configured to play a brewing completed notification sound file stored in the memory module of the controller through the speaker with a notification signal from the level sensor set to transmit a signal from the second brewing chamber to the controller. Thus, an audible notification with a human voice informs the user that the brewing process is finished on the coffee machine.

In a preferred embodiment of the invention, the level sensor in the second brewing chamber comprises a light sensor that senses the level change with the rise of the liquid level of the hot beverage in the brewing mode. Thus, it is ensured that a liquid overflow is prevented at the end of the brewing by detecting the level difference in the brewing process of the liquid in a brewing compartment in the coffee machine.

A preferred embodiment of the invention comprises a filter coffee brewing button provided as externally accessible on the control panel so as to initiate a filter coffee brewing program in the memory module when pressed. Thus, the coffee machine can make a filter coffee beverage with a brewing process by pressing a button on the control panel when desired.

A preferred embodiment of the invention comprises a Turkish coffee on the cinder brewing button provided as externally accessible on the control panel so as to initiate a Turkish coffee on the cinder brewing program in the memory module when pressed. Thus, the coffee machine can make a Turkish coffee on the cinder beverage with a brewing process by pressing a button on the control panel when desired.

A preferred embodiment of the invention comprises a tea brewing button provided as externally accessible on the control panel so as to initiate a tea brewing program in the memory module when pressed. Thus, the coffee machine can make a brewed tea beverage with a brewing process by pressing a button on the control panel when desired.

A preferred embodiment of the invention comprises a milk heating button provided as externally accessible on the control panel so as to initiate a milk heating program in the memory module when pressed. Thus, the coffee machine can heat milk with a brewing process by pressing a button on the control panel when desired.

A preferred embodiment of the invention comprises a milk beverage preparation button provided as externally accessible on the control panel so as to initiate a milk beverage preparation program in the memory module when pressed. Thus, the coffee machine can make a milk beverage with a brewing process by pressing a button on the control panel when desired.

A preferred embodiment of the invention comprises a brewing mode that is activated in the first brewing chamber by a filter coffee brewing signal transmitted to the controller when the filter coffee brewing button is pressed and then plays the brewing completed notification sound file in the memory module through the speaker 5 minutes after tripping the thermostat switch when the filter coffee is ready in the first brewing compartment. Thus, the coffee machine can notifies the user of the completion of the brewing process by a voice recording containing a human voice when a filter coffee beverage is brewed by pressing a button on the control panel.

A preferred embodiment of the invention comprises a brewing mode that is activated in the second brewing chamber by a brewing signal transmitted to the controller when the button for brewing Turkish coffee on the cinder is pressed and plays the brewing completed notification sound file in the memory module through the speaker with the notification signal from the level sensor to the processor when Turkish coffee on the cinder is ready in the second brewing compartment. Thus, the coffee machine can notifies the user of the completion of the brewing process by a voice recording containing a human voice when a Turkish coffee on the cinder beverage is brewed by pressing a button on the control panel.

A preferred embodiment of the invention comprises a brewing mode that is activated in the first brewing chamber by a tea brewing signal transmitted to the controller when the tea brewing button is pressed and then plays the brewing completed notification sound file in the memory module through the speaker 5 minutes after tripping the thermostat switch when the tea is ready in the first brewing compartment. Thus, the coffee machine can notifies the user of the completion of the brewing process by a voice recording containing a human voice when a tea is brewed by pressing a button on the control panel.

A preferred embodiment of the invention comprises a brewing mode that is activated in the second brewing chamber by a milk heating signal transmitted to the controller when the milk heating button is pressed and plays the heating completed notification sound file in the memory module through the speaker with the notification signal from the level sensor to the processor when the milk boils in the second brewing compartment. Thus, the coffee machine can notifies the user of the completion of the heating process by a voice recording containing a human voice when the milk is heated by pressing a button on the control panel.

A preferred embodiment of the invention comprises a brewing mode that is activated in the second brewing chamber by a milk beverage preparation signal transmitted to the controller when the milk beverage preparation button is pressed and plays the preparation completed notification sound file in the memory module through the speaker with the notification signal from the level sensor to the processor when the milk beverage is ready in the second brewing compartment. Thus, the coffee machine can notifies the user of the completion of the heating process by a voice recording containing a human voice when a milk beverage is prepared by pressing a button on the control panel.

A preferred embodiment of the invention comprises the information of “filter coffee brewing completed” in the brewing completed notification sound file. Thus, the coffee machine can make a filter coffee using a filter coffee brewing program.

A preferred embodiment of the invention comprises the information of “Turkish coffee on the cinder brewing completed” in the brewing completed notification sound file. Thus, the coffee machine can make a Turkish coffee on the cinder using a Turkish coffee on the cinder brewing program.

A preferred embodiment of the invention comprises the information of “tea brewing completed” in the brewing completed notification sound file. Thus, the coffee machine can make a tea using a tea brewing program.

A preferred embodiment of the invention comprises an information of “milk heating completed” in the brewing completed notification sound file. Thus, the coffee machine can heat milk using a milk heating program.

A preferred embodiment of the invention comprises the information of “milk beverage preparation completed” in the brewing completed notification sound file. Thus, the coffee machine can prepare a milk beverage using a milk beverage preparation program.

### BRIEF DESCRIPTION OF THE DRAWINGS

FIG. 1 is a schematic illustration of a coffee machine of the invention.

### DETAILED DESCRIPTION OF INVENTION

In this detailed description, the subject matter of the invention has been illustrated by way of non-exhaustive examples that only serve to better explain the subject.

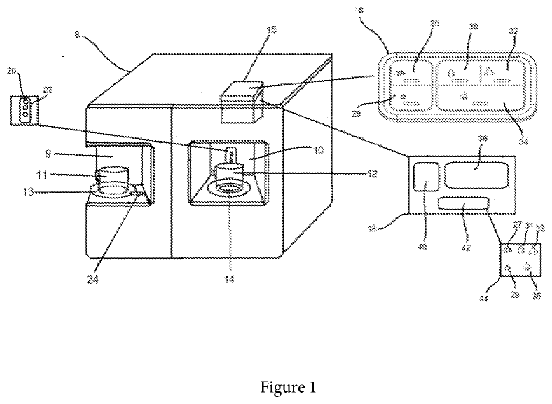

FIG. 1 shows a schematic illustration of the envisaged coffee machine. The coffee machine comprises a housing (8) that is rectangle, is made of the hardened plastic or metal material and also provides protection. The housing (8) is provided with a control panel (15) to be located on the top of housing. The control panel (15) includes a Turkish coffee on the cinder brewing button (34) and a filter coffee brewing button (28) to activate a brewing mode (16). When the Turkish coffee on the cinder brewing button (34) is pressed, the brewing mode (16) to brew the Turkish coffee is activated. When the filter coffee brewing button (28) is pressed, the brewing mode (16) to brew the filter coffee is activated. The control panel also includes the following buttons provided as externally accessible:
A tea brewing button (26) that activates the brewing mode (16) to brew tea
A milk heating button (30) that activates the brewing mode (16) to heat milk
A milk beverage brewing button (32) that activates the milk beverage brewing mode (16)

Again, there is a first brewing chamber (9) and a second brewing chamber (10) in which the brewing is carried out and which are located in the body part of the housing (8) and have a space. At the bottom of the first brewing chamber (9), there is a first heating plate (13) where the heating is carried out by converting mains power into heat energy. Above the first heating plate (13), there is provided a first brewing compartment (11) for brewing the filter coffee placed therein. A thermostat switch (24) is provided in the first brewing chamber (9), which is set to transmit the mains power to the first heating plate (13) when a brewing mode is activated (16) while the coffee is brewing in the first brewing compartment (11), and which is set to disconnect from the mains power by switching the brewing mode (16) to off at the appropriate temperature of the coffee brewing process. In the second brewing chamber (10), there is a second brewing compartment (12) placed. In the second brewing compartment (12), there is a second heating plate (14) located at the bottom of the second brewing chamber, where the heating is carried out by converting the mains power into heat energy. The coffee machine of the invention also comprises a controller (18) with a processor (36) to transmit signals from the first brewing chamber (9) and the second brewing chamber (10), a memory module (40) and a speaker (42). In a brewing mode of the first brewing compartment (11) in the first brewing chamber (9), the controller (18) receives a notification signal from the tripped thermostat switch (24) set to transmit a signal from the first brewing chamber (9), and then plays a brewing completed notification sound file (44) stored in the memory module (40) of the controller (18) through the speaker (42) after 5 minutes in an audio frequency that can be heard by an user. Also in a brewing mode of the second brewing compartment (12) in the second brewing chamber (10), fluid level is checked by a level sensor (20). The level sensor (20) is set to send a signal in order to end the brewing at a certain threshold of the liquid level. Here, the level sensor (20) is configured to transmit a signal to the controller (18). And the level sensor (20) is a level sensor (20) located at a rear side of the second brewing chamber (10) to sense the entire brewing compartment. There are photocells arranged in a row on a strip line on the level sensor (20). Each photocell herein is a light sensor (22) that detects by light path and is configured to transmit a signal to a controller (18). A coffee machine using a luminescence technology can be provided with the light sensor (22). The luminescence technology is described in the cited patent no. 2015/07207. The light sensor (22) is set to operate via the controller (18). Here, in a brewing mode, the second heater plate (14) located on the bottom of the second brewing compartment (12) is set to provide power from the mains, and when the brewing is finished, to cut off the power by detecting with the level sensor (20) and to send an electrical signal to the controller (18). Here, the controller (18) comprises a processor (36), a memory module (40) and a speaker (42) connected to the controller in such a way that an electrical signal flow occurs, and the processor (36) primarily comprises software in such a way that the signal is transmitted and the brewing is carried out. The memory module (40) receives a notification signal from the level sensor (20) to the controller. The memory module (40) contains notification sound files (44) having the following information for a relevant brewing program of the brewing mode (16) ends:
A notification sound file (44) containing a filter coffee brewing completed information (29)
A notification sound file (44) containing a Turkish coffee brewing completed information (35)
A notification sound file (44) containing a tea brewing completed information (27)
A notification sound file (44) containing a milk heating completed information (31)
A notification sound file (44) containing a milk beverage preparation completed information (33)

A notification sound file (44) containing the completed information (27) (29) (31) (33) (35) is transferred from the memory module to the speaker. The speaker (42) is set to play the sound file (44) in order to transmit the relevant information to the user in an audible frequency. When a brewing mode is activated by pressing a button (26) (28) (30) (32) (34) of the coffee machine, the following brewing processes are carried out:
When the tea brewing button (26) is pressed, the entire tea and water mixture in the first brewing compartment (11) in the first brewing chamber (9) is set to be brewed by heating, e.g. tea brewing using dripping type brewing, and after a brewing time, e.g. 5 minutes, the thermostat switch (24) trips to cut off the mains power, and after the thermostat switch (24) trips, the controller (18) is set to wait for about 5 minutes in a brewing time, and then the sound file (44) is played through the speaker (42) in the controller (18) to transmit the information of “Your tea is ready” to the user.
When the filter coffee brewing button (28) is pressed, the entire coffee and water mixture in the first brewing compartment (11) in the first brewing chamber (9) is set to be brewed by heating, e.g. filter coffee brewing using dripping type brewing, and after a brewing time, e.g. 5 minutes, the thermostat switch (24) trips to cut off the mains power, and after the thermostat switch (24) trips, the controller (18) is set to wait for about 5 minutes in a brewing time, and then the sound file (44) is played through the speaker (42) in the controller (18) to transmit the information of “Your coffee is ready” to the user.
When the milk heating button (30) or the milk beverage button (32) is pressed, the entire beverage in the second brewing compartment (12) in the second brewing chamber (10) is set to be heated and the luminescence technology (20) (22) sends signals to the controller (18) to detect when the prepared beverage is brewed and cuts off the mains power; the controller (18) switches off the mains power at a pre-specified time, e.g. at a pre-specified brewing time of 5 minutes, in accordance with the results of a test carried out in an electronic testing laboratory, if the beverage is not sufficiently risen; then the controller (18) checks which brewing button (30) (32) set to be connected to the controller (18) is active in order to detect which product is brewed; according to the button (30) (32) pressed, the sound file (44) is played through the speaker (42) on the controller (18) at the end of the brewing to transmit the information of “Your milk is ready” or “Your milk drink is ready” to the user.
When the Turkish coffee on the cinder brewing button (34) is pressed, the entire beverage in the second brewing compartment (12) in the second brewing chamber (10) is set to be heated and the luminescence technology (20) (22) sends signals to the controller (18) to detect when the prepared beverage is brewed and the mains power is cut off; then the controller (18) checks which brewing button set to be connected to the controller is active in order to understand which product is brewed; according to the button pressed, the sound file (44) is played through the speaker (42) on the controller (18) at the end of the brewing to transmit the information of “Your Turkish coffee is ready” to the user.

### REFERENCE NUMBERS

8 Housing
9 First brewing chamber
10 Second brewing chamber
11 First brewing compartment
12 Second brewing compartment
13 First heating plate
14 Second heating plate
15 Control panel
16 Brewing mode
18 Controller
20 Level sensor
22 Light sensor
24 Thermostat switch
26 Tea brewing button
27 Tea brewing completed information
28 Filter coffee button
29 Filter coffee brewing completed information
30 Milk heating button
31 Milk heating completed information
32 Milk beverage preparation button
33 Milk beverage preparation completed information
34 Turkish coffee on the cinder button
35 Turkish coffee brewing completed information
36 Processor
40 Memory module
42 Speaker
44 Brewing completed notification sound file

1- A coffee machine comprising a first brewing chamber (9) and a second brewing chamber (10) arranged in a housing (8); a first heating plate (13) arranged at the bottom of the first brewing chamber (9); a first brewing compartment (11) located in the first brewing chamber (9) and aligned on the first heating plate (13); a second brewing compartment (12) located in the second brewing chamber (10); a second heating plate (14) located at a bottom of the second brewing compartment (12); a level sensor (20) configured to detect a threshold of the liquid level in a brewing mode of the second brewing compartment (12); a thermostat switch (24) configured to transmit mains power to the first heating plate (13) when a brewing mode (16) is on and to disconnect the mains power from the first heating plate (13) when the brewing mode (16) is off; a control panel (15) for selecting the brewing mode (16) and one or more brewing buttons (26) (28) (30) (32) (34) located thereon, wherein it is comprised of a controller (18) having a processor (36), a memory module (40) and a speaker (42) associated with a signal transmission from the first brewing chamber (9) and the second brewing chamber (10); being the controller (18) configured to receive a notification signal by tripping the thermostat switch (24) set to transmit a signal from the first brewing chamber (9), and to wait for 5 minutes and then to play a brewing completed notification sound file (44) stored in a memory module (40) of the controller (18) through a speaker (42); and being the controller (18) also configured to play a brewing completed notification sound file (44) stored in the memory module (40) of the controller through the speaker (42) with a notification signal from the level sensor (20) set to transmit a signal from the second brewing chamber (10) to the controller (18).

2- A coffee machine according to claim 1, wherein the level sensor (20) in the second brewing chamber (10) comprises a light sensor (22) that senses the level change with the rise of the liquid level of the hot beverage in the brewing mode (16).

3- A coffee machine according to claim 1, wherein it comprises a filter coffee brewing button (28) provided as externally accessible on the control panel (15) so as to initiate a filter coffee brewing program in the memory module (40) when pressed.

4- A coffee machine according to claim 1, wherein it comprises a Turkish coffee on the cinder brewing button (34) provided as externally accessible on the control panel (15) so as to initiate a Turkish coffee on the cinder brewing program in the memory module (40) when pressed.

5- A coffee machine according to claim 1, wherein it comprises a tea brewing button (26) provided as externally accessible on the control panel (15) so as to initiate a tea brewing program in the memory module (40) when pressed.

6- A coffee machine according to claim 1, wherein it comprises a milk heating brewing button (30) provided as externally accessible on the control panel (15) so as to initiate a milk heating program in the memory module (40) when pressed.

7- A coffee machine according to claim 1, wherein it comprises a milk beverage preparation button (32) provided as externally accessible on the control panel (15) so as to initiate a milk beverage preparation program in the memory module (40) when pressed.

8- A coffee machine according to claim 3, wherein it comprises a brewing mode (16) that is activated in the first brewing chamber (9) by a filter coffee brewing signal transmitted to the controller (18) when the filter coffee brewing button (28) is pressed and then plays the brewing completed notification sound file (44) in the memory module (40) through the speaker (42) 5 minutes after tripping the thermostat switch (24) when the filter coffee is ready in the first brewing compartment (11).

9- A coffee machine according to claim 4, wherein it comprises a brewing mode (16) that is activated in the second brewing chamber (10) by a brewing signal transmitted to the controller (18) when the button for brewing Turkish coffee on the cinder (34) is pressed and plays the brewing completed notification sound file (44) in the memory module (40) through the speaker (42) with the notification signal from the level sensor (20) to the processor (36) when Turkish coffee on the cinder is ready in the second brewing compartment (12).

10- A coffee machine according to claim 5, wherein it comprises a brewing mode (16) that is activated in the first brewing chamber (9) by a tea brewing signal transmitted to the controller (18) when the tea brewing button (26) is pressed and then plays the brewing completed notification sound file (44) in the memory module (40) through the speaker (42) 5 minutes after tripping the thermostat switch (24) when the tea is ready in the first brewing compartment (11).

11- A coffee machine according to claim 6, wherein it comprises a brewing mode (16) that is activated in the second brewing chamber (10) by a milk heating signal transmitted to the controller (18) when the milk heating button (30) is pressed and plays the brewing completed notification sound file (44) in the memory module (40) through the speaker (42) with the notification signal from the level sensor (20) to the processor (36) when milk is ready in the second brewing compartment (12).

12- A coffee machine according to claim 7, wherein it comprises a brewing mode (16) that is activated in the second brewing chamber (10) by a milk beverage preparation signal transmitted to the controller (18) when the milk beverage preparation button (32) is pressed and plays the brewing completed notification sound file (44) in the memory module (40) through the speaker (42) with the notification signal from the level sensor (20) to the processor (36) when milk beverage is ready in the second brewing compartment (12).

13- A coffee machine according to claim 8, wherein the brewing completed notification sound file (44) contains a filter brewing completed information (29).

14- A coffee machine according to claim 9, wherein the brewing completed notification sound (44) file contains a Turkish coffee brewing completed information (35).

15- A coffee machine according to claim 10, wherein the brewing completed notification sound file (44) contains a tea brewing completed information (27).

16- A coffee machine according to claim 11, wherein the brewing completed notification sound file (44) contains a milk heating completed information (31).

17- A coffee machine according to claim 12, wherein the brewing completed notification sound file (44) contains a milk beverage brewing completed information (33).
